(19) United States
(12) Patent Application Publication
(10) Pub. No.: US 2019/0151168 A1
(43) Pub. Date: May 23, 2019

(54) WHEELCHAIR PUSH RIM DEVICE

(71) Applicant: FULL CIRCLE INVENTION, LLC, Warrington, PA (US)

(72) Inventors: Kreg Erik Jones, Jenkintown, PA (US); Eric T. Goldstein, Warrington, PA (US)

(21) Appl. No.: 16/138,389

(22) Filed: Sep. 21, 2018

Related U.S. Application Data
(60) Provisional application No. 62/591,483, filed on Nov. 28, 2017.
(60) Provisional application No. 62/562,221, filed on Sep. 22, 2017.

(51) Int. Cl. A61G 5/02

(52) U.S. Cl. CPC A61G 5/022; A61G 5/1054; A61G 5/026; A61G 5/028

(57) ABSTRACT

A push rim assembly for use with a wheelchair that prevents or minimizes direct contact of a user's upper extremity (arm, wrist, hand, fingers) with at least a portion of the wheelchair tire or wheelchair push rim.

### REFERENCE TO RELATED APPLICATIONS

In accordance with 37 C.F.R 1.76, a claim of priority is included in an Application Data Sheet filed concurrently herewith. Accordingly, the present application claims priority to U.S. Provisional Patent Application No. 62/562,221, filed on Sep. 22, 2017, entitled, “WHEELCHAIR PUSH RIM DEVICE” and U.S. Provisional Patent Application No. 62/591,483, filed on Nov. 28, 2017, entitled, “WHEELCHAIR PUSH RIM DEVICE”. The contents of each of the above referenced applications are herein incorporated by reference in their entirety.

### FIELD OF THE INVENTION

The present invention relates to manually operated mobility devices; to a protective device for use with a manual wheelchair; and more particularly, to a manual wheelchair push rim assembly which prevents or minimizes direct contact of a user's upper extremity (arm, wrist, hand, fingers) with the wheelchair wheel or wheelchair push rim when in use.

### BACKGROUND OF THE INVENTION

Hand hygiene is known as an important component in reducing healthcare-associated infections and preventing occupationally acquired infections, see Association for Professionals in Infection Control and Epidemiology, Guide to Hand Hygiene Programs for Infection Prevention, First Edition, June 2015. Manually propelled wheelchairs are a known mode of transmission of infectious microorganisms and debris from health facility administrations to wheelchair users in the community alike. Though figures vary slightly, data shows approximately 1.0 to 1.5 percent of the U.S. population, as well as other key developed countries, are dependent on manual wheelchair use. Accordingly, there are approximately 3.3 million wheelchair users in the U.S. alone. A larger percentage of the population is dependent on other mobility aides such as canes, crutches and walkers, with potential for their own decline to wheelchair necessity. It is anticipated that the number will increase over the next several years due to the aging baby boomer generation. Also, advances in modern medicine continuously reshape the landscape where illnesses once deadly are scientifically reshaped into chronic and/or degenerative conditions.

While clinicians and administrators of health care facilities are well aware that manual wheelchairs are known modes of transmission of microorganisms, no known universal standards exist to manage such wheelchair offenses. Economic, effective, and efficient solutions are in demand. Equally important to health care facility stakeholders, wheelchair users in the community are at a loss for an affordable, simple, and effective solution. What is needed in the art is a device which prevents or minimizes user exposure to disease carrying microorganisms or other debris. Moreover, a device which eliminates the need for a wheelchair user to wear protective performance gloves yet maintain cleanliness is also required.

### SUMMARY OF THE INVENTION

The present invention relates to a manual push rim device for users of manual mobility devices such as wheelchairs. The push rim device is designed to act as a barrier, preventing microorganisms and debris from contaminating one or more portions of a user's upper extremity, such as the hands and/or wrists, during routine manual mobility device use. The wheelchair push rim device is designed to easily secure to a portion of an existing wheelchair unit.

The push rim assembly is designed to be sized to extend from the central wheel bolt of any standard wheelchair, where it is easily attached to any bolt assembly. Originating at the hub, the push rim assembly may be sized to extend toward a push rim. The push rim assembly may also be configured to terminate parallel in height with or cover the top of the wheel surface. The push rim assembly is also designed to glide free of friction, forward and rearward, when contact pads are not being engaged. The entire assembly is low impact and does not widen the mobility device enough to effect thoroughfare about usual terrain and passageways.

In an illustrative embodiment, a push rim device for use with a manual mobility device having at least one drive wheel and at least one push rim may comprise a first elongated appendage having a first end and a second, opposing end; a second elongated appendage having a first end and a second, opposing end; a push rim cover sized and shaped to provide a barrier to protect a user's hand from direct contact with at least a portion of a manual wheel chair having at least one pair of drive wheels and a push rim; a wheel axle engaging member secured to or integrally formed to the second opposing end of the first elongated appendage and the second opposing end of the second elongated member. The push rim cover comprises a main body sized and shaped to simultaneously cover at least a portion of the wheelchair wheel and at least a portion of the wheelchair push rim.

In another illustrative embodiment, a push rim device for use with a wheel chair may comprise a push rim cover sized and shaped to provide a barrier to protect a user's hand from direct contact with at least a portion of a manual mobility device having at least one pair of drive wheels and a push rim, said push rim cover sized and shaped to simultaneously cover at least a portion of said wheelchair wheel and at least a portion of said wheelchair push rim; and at least one elongated appendage having a first end secured to a wheel chair hub and a second, opposing end secured to or integrally formed to said push rim cover. The push rim device may include a first elongated appendage and a second elongated appendage, said first elongated appendage separated from said second elongated appendage by a space.

In another illustrative embodiment, a wheelchair with a protective push rim assembly may comprise a frame having cross braces supporting a seat; a backrest; one or more side panels; a pair of front wheels; a pair of drive wheels, said drive wheels being larger than said pair of front wheels; at least one push rim; and a push rim assembly. The push rim assembly comprises a first elongated appendage having a first end and a second, opposing end; a second elongated appendage having a first end and a second, opposing end; a push rim cover sized and shaped to provide a barrier to protect a user's hand from direct contact with at least a portion of a manual wheel chair having at least one pair of drive wheels and a push rim; a wheel axle engaging member secured to or integrally formed to the second, opposing end of the first elongated appendage and the second, opposing end of the second elongated member. The push rim cover may comprise a main body sized and shaped to simultaneously cover at least a portion of each wheel of the pair of drive wheels, and at least a portion of the at least one push rim.

Accordingly, it is an objective of the invention to provide a protective device for use with a wheelchair.

It is a further objective of the invention to provide a device for use with a wheelchair that prevents or minimizes direct contact of a user's upper extremity (arm, wrist, hand, fingers) with at least a portion of wheelchair tire.

It is a further objective of the invention to provide a device that prevents or minimizes the spread of disease or contamination associated with wheelchair push rims.

It is a still further objective of the invention to provide a protective device which eliminates the need for a wheelchair user to wear protective performance gloves during use.

Other objectives and advantages of this invention will become apparent from the following description taken in conjunction with any accompanying drawings wherein are set forth, by way of illustration and example, certain embodiments of this invention. Any drawings contained herein constitute a part of this specification, include exemplary embodiments of the present invention, and illustrate various objects and features thereof.

### BRIEF DESCRIPTION OF THE FIGURES

FIG. 1 is a perspective view of the back of a wheelchair, the wheelchair having a protective wheelchair push rim assembly;

FIG. 2 is a close-up, perspective view of the wheelchair having a protective wheelchair push rim assembly secured to the right drive wheel;

FIG. 3 is a front perspective view of an illustrative example of a push rim cover;

FIG. 4 is a back perspective view of the push rim cover shown in FIG. 3;

FIG. 5 illustrates the push rim cover with an example of a wheelchair wheel securing assembly;

FIG. 6 is a partial view of the push rim assembly engaged with a wheelchair push rim;

FIG. 7 is a schematic view of the push rim assembly secured to a wheelchair wheel, illustrating the independent movement of the push rim assembly relative to the wheel;

FIG. 8 illustrates an alternative embodiment of the push rim assembly;

FIG. 9 is a partial view of the push rim assembly shown in FIG. 8, illustrating an interior portion.

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

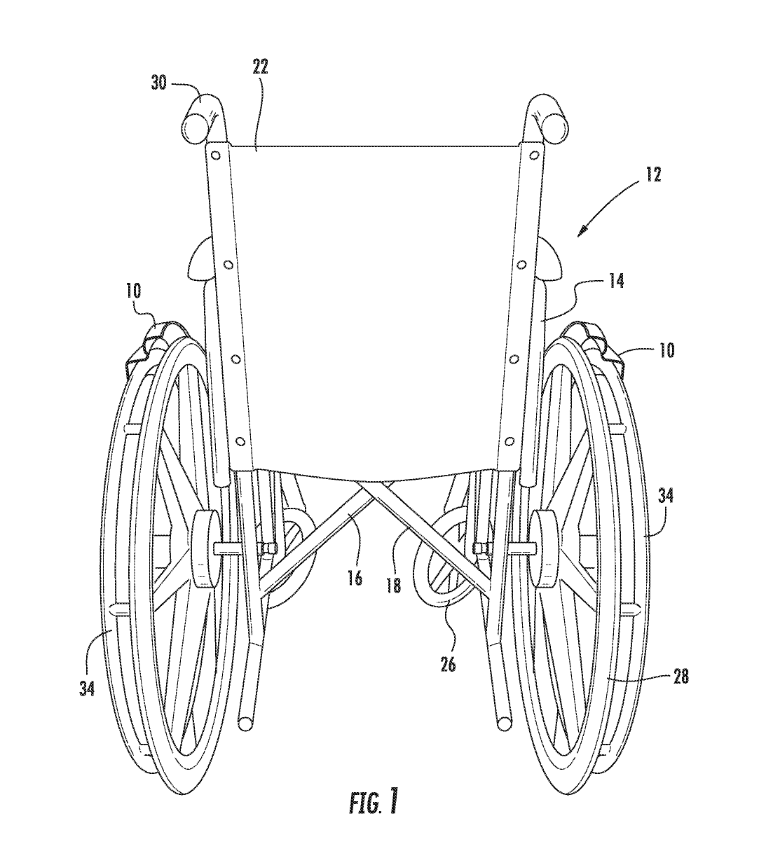

Referring to FIG. 1, an illustrative embodiment of a protective push rim, referred to generally as a push rim assembly 10, is secured to a typical wheelchair 12. The push rim assembly 10 may be composed of any material, preferably a lightweight material such as plastic or metal. In general, the wheelchair 12 contains a frame 14 with cross braces 16 and 18 supporting a seat 20, backrest 22, and side panels 24 constructed and arranged to allow a user to sit on the seat 20 and be pushed from one location to another location. Two pairs of wheels, a small front pair 26, illustrated as castor wheels, and a larger back pair, or drive wheels 28, allow the wheelchair to be moved by the wheelchair user, or by a third person using pushing handles 30. The drive wheels 28 are composed of a drive wheel outer rim 32, which may have a rubber tire. Attached to the drive wheel 28 is a push rail or push rim 34, which an occupant of the wheelchair 12 may use to manually rotate the drive wheels 28 and move the wheelchair 12 from one location to another.

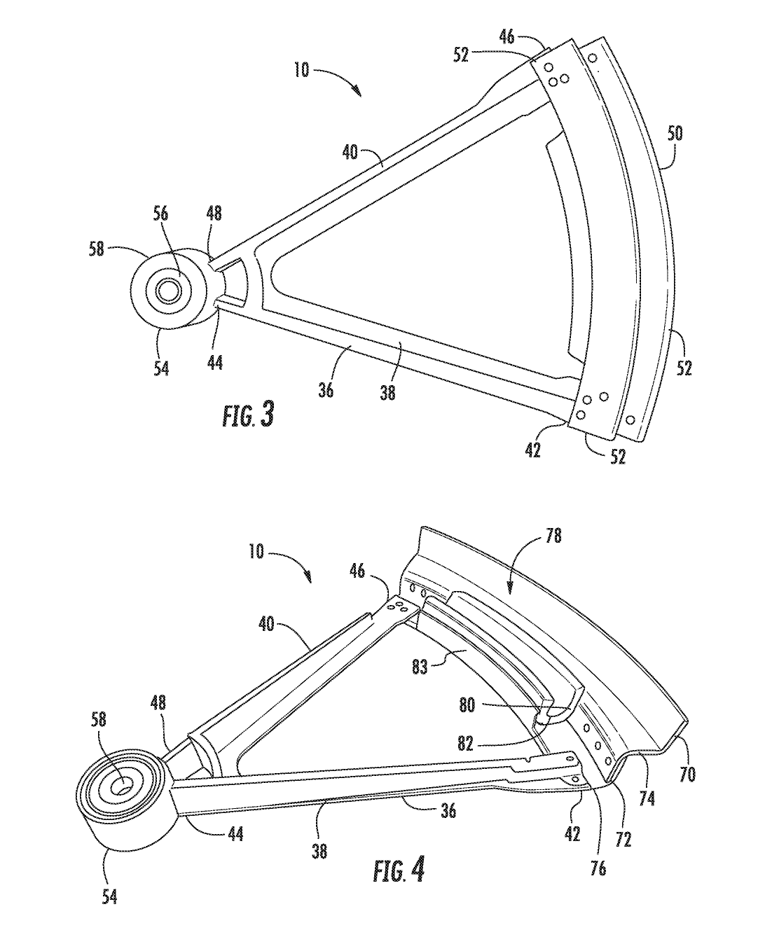

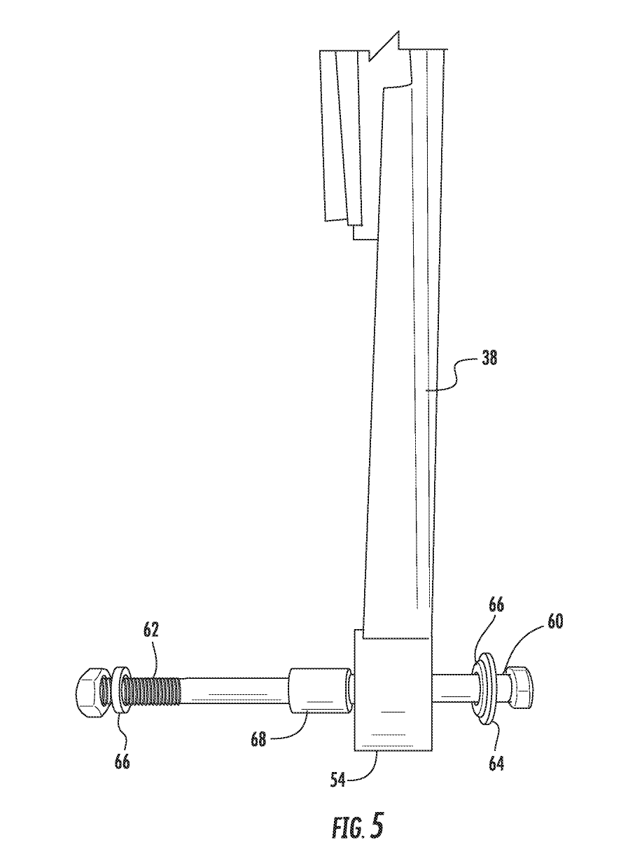

FIGS. 3 and 4 provide an illustrative embodiment of the push rim assembly 10. The push rim assembly 10 includes a main body 36 comprising a pair of elongated arm-like appendages 38 and 40. The elongated arm-like appendage 38 contains a first end 42 and an opposing second end 44. The elongated arm-like appendage 40 contains a first end 46 and an opposing second end 48. Secured to, or integrally formed from, the first end 42 of the elongated arm-like appendage 38 and the first end 46 of the elongated arm-like appendage 40 is a push rim cover 50. This push rim cover 50 is designed to provide a barrier to protect the user's hands from direct contact with the wheelchair wheel or the push rim 34. Thus, any microorganisms or debris collected, as the tire and push rim spin toward the ground and back toward the hands with each revolution, do not contact the user's hand.

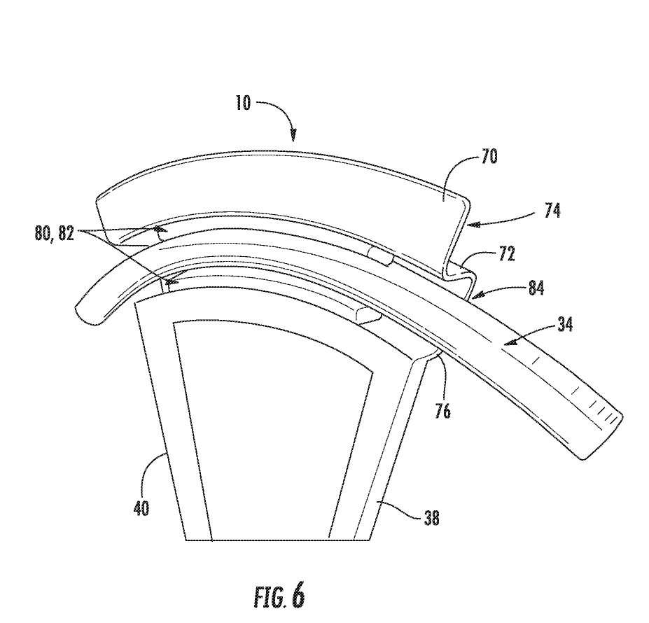

As illustrated, the push rim cover 50 is secured to the elongated arm-like appendages 38 and 40 through securing members, illustrated herein as screws 52. Secured to, or integrally formed from, the second end 44 of the elongated arm-like appendage 38 and the second end 48 of the elongated arm-like appendage 40 is a wheelchair wheel axle engaging member 54. The wheelchair wheel axle engaging member 54 is illustrated as having a generally circular or tubular body 56 having a centrally positioned opening 58. The centrally positioned opening 58 is sized and shaped to receive and hold an elongated bolt 60, see FIG. 5, having a threaded end 62 and including a washer 64, inner and outer cap bearings 66, and a spacer 68, thereby providing a mechanism for the push rim assembly 10 to be securable and movable to a portion of the wheelchair, i.e. the push rail or push rim 34 or the drive wheel 28.

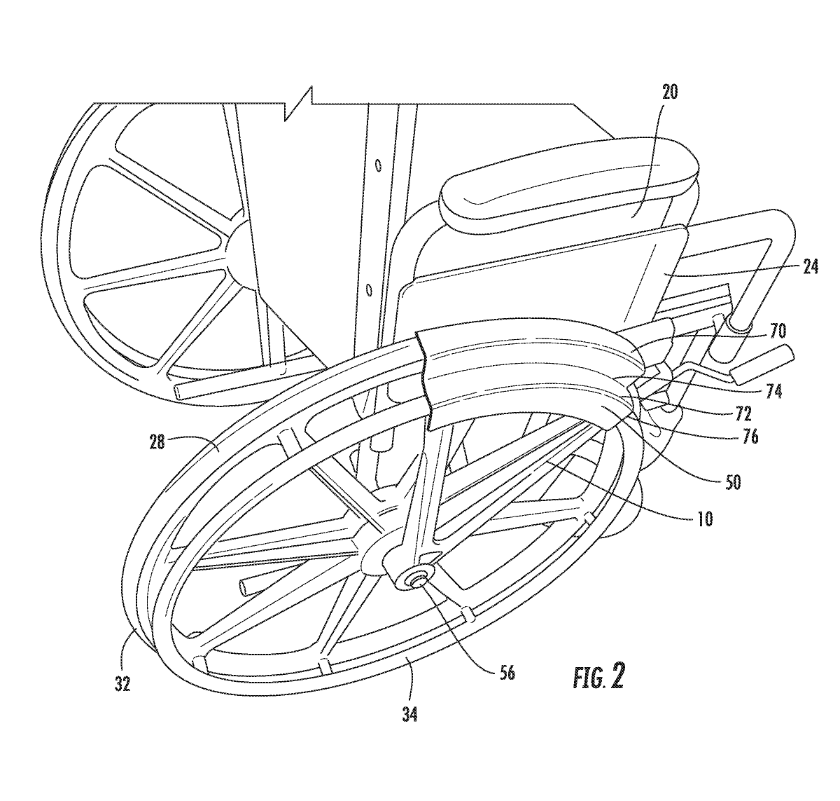

Referring back to FIGS. 2, 3 and 4, the push rim cover 50 comprises a main body 52 sized and shaped to simultaneously cover at least a portion of the wheelchair wheel 28 and at least a portion of the wheelchair push rail or push rim 34 (see FIG. 2). The push rim cover main body 52 may be configured with a partially curved shape to mirror the partial curvature of the wheelchair wheel 28 and at least a portion of the wheelchair push rail or push rim 34. The push rim cover main body 52 preferably comprises two stepped surfaces, 70 and 72, separated by a connecting wall or surface 74. Extending from the stepped surface 72 is a side wall or surface 76. The side wall or surface 76 is sized to extend past the push rim 34.

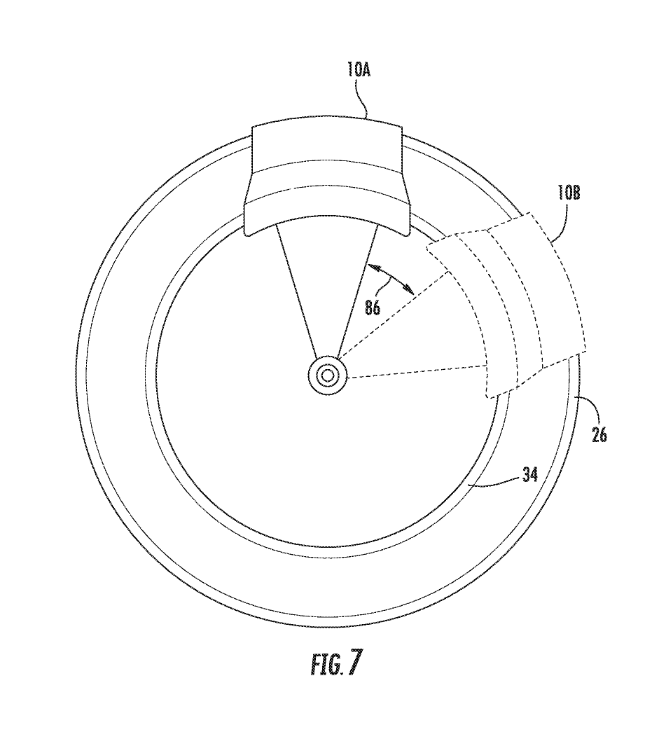

Secured to the inner surface 78 of the push rim cover main body 52 is one or more contact pads, illustrated herein as an upper contact pad 80 and a lower contact pad 82. The upper contact pad 80 and lower contact pad 82 are arranged in a generally parallel orientation relative to each other, with a gap or space 84 (see FIG. 6) between them. The gap or space 84 is sized to allow at least a portion of the push rim 34 to be placed therebetween. The push rim cover main body 52 may also contain a lower contact pad support structure 83. The upper pad 82 may be secured within the inner portion or side of the first stepped surface 72. The upper contact pad 80 and lower contact pad 82 allow the user to control the motion of the wheelchair 12.

In an illustrative embodiment, the upper contact pad 80 or the lower contact pad 82 may be replaceable, as may be necessary due to wear. The upper contact pad 80 or the lower contact pad 82 is preferably situated to make contact with the top, lateral, and under side portions of the push rim 34. These contact points replicate the contact points made when a user's hand is engaging the push rim 34 in the traditional fashion. The margins of spacing between the upper contact pad 80, the lower contact pad 82, and the push rim 34 are preferably minimal to the extent that the exertion put forth during use with the device is less than or equal to, but not greater than, the exertion put forth during traditional manual propulsion.

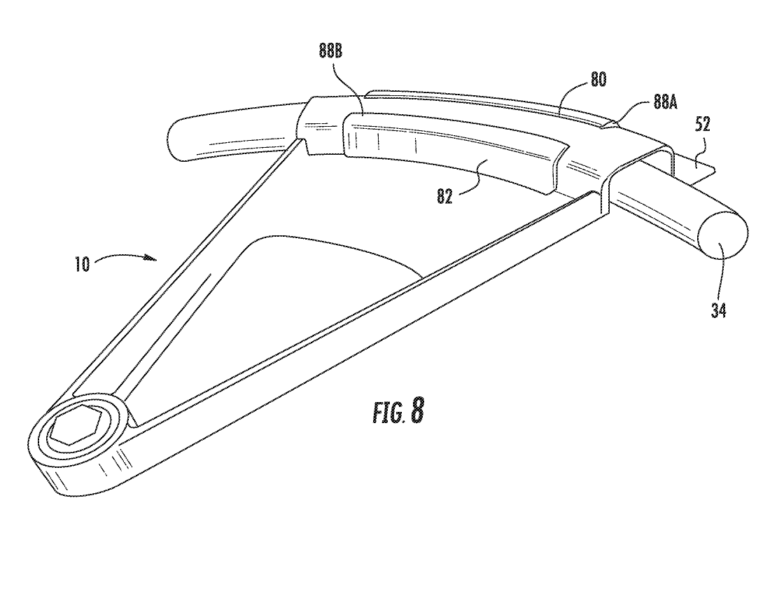

Accordingly, when in use, the user uses their hand, preferably applying their thumb and thumb pad on the upper contact pad 80, to apply a downward compressive force onto the push rim cover main body 52. The user then applies an upward compressive force by applying their remaining fingers to the lower contact pad 82. The upward compressive force or downward compressive force, alone or in combination, allows the user to engage the contact pads 80, 82 to grip the push rim 34. Using either a forward pushing motion or rearwards pulling motion, propulsion or breaking forces in that direction can be created. The push rim assembly 10 is secured to the wheelchair 12 in a manner that allows the push rim assembly 10 to move independently of the wheelchair wheel 28 when required. Accordingly, when the user wants to move the wheelchair 12 in a particular direction, he/she engages the push rim cover main body 52 without applying a force to the upper contact pad 80 and the lower contact pad 82. This allows the wheelchair axle engaging member 54 to move or rotate in a forward or backward motion, see double arrow head 86 in FIG. 7, about the circumference of the wheelchair wheel 26 or wheelchair push rim 34. This allows the user to move the push rim assembly 10 from a first position along the wheelchair wheel 28 or wheelchair push rim 34 (10A, FIG. 7) to a second position along the wheelchair wheel 28 or wheelchair push rim 34 (10B, FIG. 7, in broken lines to indicate that the push rim assembly 10 has been moved from its original location). Once in the second location, the user can then engage the contact pads 80, 82. Applying a force at this time will then move all components, i.e. the wheelchair wheel 28, the wheelchair push rim 34, and the push rim assembly 10. When the user disengages the push rim assembly 10, the push rim assembly 10 is then free to rotate or be moved independently of the wheelchair wheel 28 or wheelchair push rim 34.

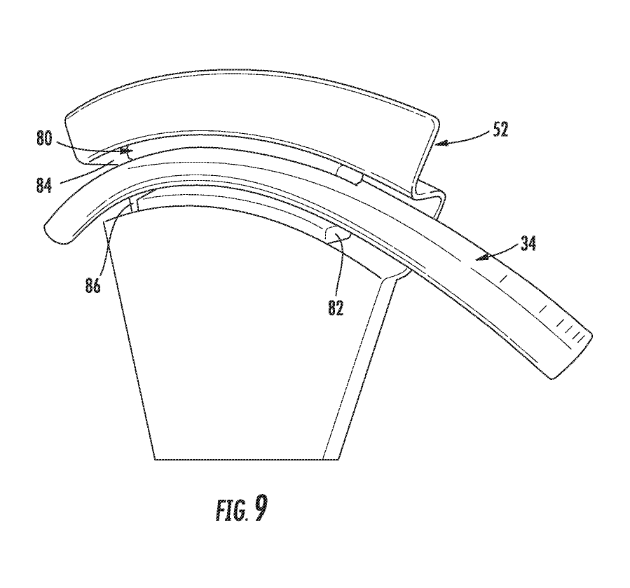

FIG. 8 illustrates an alternative embodiment of the push rim assembly 10, in which the push rim cover main body 52 comprises slotted openings 88A and 88B, which are sized and shaped to allow the contact pads 80, 82 to extend therethrough. FIG. 9 illustrates an interior view, i.e. the portion of the push rim assembly 10 that faces or is in contact with the wheelchair wheel. As shown, the contact pads 80, 82 are arranged in a generally parallel orientation relative to each other and have a space 84, 86 separating each contact pad 80, 82 with the push rim 34. Space 84, 86 allows the push rim freedom of movement unless a user applies a force to the contact pads 80, 82, thus clamping down onto the push rim 34. When in use, the user applies their thumb and thumb pad on the contact pad 80, using a downward compressive force, and the remaining fingers on the underside contact pad 82, using an upward compressive force. Either force alone, and especially when used in combination, will engage the contact pads 80, 82 to grip the push rim 34, and with either a forward pushing or rearward pulling motion, will create propulsion or breaking in that direction.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention, and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A push rim device for use with a manual mobility device having at least one drive wheel and at least one push rim, said push rim device comprising:
a first elongated appendage having a first end and a second, opposing end;
a second elongated appendage having a first end and a second, opposing end;
a push rim cover sized and shaped to provide a barrier to protect a user's hand from direct contact with at least a portion of a manual wheel chair having at least one pair of drive wheels and a push rim;
a wheel axle engaging member secured to or integrally formed to said second, opposing end of said first elongated appendage and said second opposing end of said second elongated member.

2. The push rim device for use with a manual mobility device according to claim 1 wherein said push rim cover comprises a main body sized and shaped to simultaneously cover at least a portion of said wheelchair wheel and at least a portion of said wheelchair push rim.

3. The push rim device for use with a manual mobility device according to claim 2 wherein said push rim cover main body comprises at least one stepped surface.

4. The push rim device for use with a manual mobility device according to claim 3 wherein said push rim cover main body comprises two stepped surfaces separated by a connecting wall or surface.

5. The push rim device for use with a manual mobility device according to claim 3 further including one or more pads secured to an inner surface of said main body.

6. The push rim device for users of manual mobility devices according to claim 5 wherein said one or more pads secured to said inner surface of said main body include an upper contact pad and a lower contact pad, said upper contact pad and said lower contact pad arranged in a generally parallel orientation relative to each other, with a space therebetween.

7. The push rim device for use with a manual mobility device according to claim 6 wherein said space is sized to allow at least a portion of said push rim to be placed therebetween.

8. The push rim device for use with a manual mobility device according to claim 6 wherein said space is sized to allow at least a portion of said push rim to move within, without making contact unless a force is applied to said upper contact pad or said lower contact pad.

9. The push rim device for use with a manual mobility device according to claim 1 wherein said wheel axle engaging member is secured to said wheel hub through a securing member.

10. The push rim device for use with a manual mobility device according to claim 5 wherein said push rim is also designed to glide free of friction, forward and rearward, when said one or more pads are not engaged.

11. A push rim device for use with a wheel chair comprising:
a push rim cover sized and shaped to provide a barrier to protect a user's hand from direct contact with at least a portion of a wheel chair having at least one pair of drive wheels and a push rim, said push rim cover sized and shaped to simultaneously cover at least a portion of said wheelchair wheel and at least a portion of said wheelchair push rim; and
at least one elongated appendage having a first end secured to a wheel chair hub and a second, opposing end secured to or integrally formed to said push rim cover.

12. The push rim device for use with a wheel chair according to claim 11 including a first elongated appendage and a second elongated appendage, said first elongated appendage separated from said second elongated appendage by a space.

13. The push rim device for use with a wheel chair according to claim 11 wherein said push rim cover comprises a partially curved shape which mirrors a shape of a partial curvature of a wheelchair wheel or wheelchair push rim.

14. The push rim device for use with a wheel chair according to claim 11 further including one or more pads secured to an inner surface of said push rim cover.

15. A wheelchair with a protective push rim assembly comprising:
a frame having cross braces supporting a seat;
a backrest;
one or more side panels;
a pair of front wheels;
a pair of drive wheels, said drive wheels being larger than said pair of front wheels;
at least one push rim; and
a push rim assembly, said push rim assembly comprising:
a first elongated appendage having a first end and a second, opposing end;
a second elongated appendage having a first end and a second, opposing end;
a push rim cover sized and shaped to provide a barrier to protect a user's hand from direct contact with at least a portion of a manual wheel chair having at least one pair of drive wheels and a push rim;
a wheel axle engaging member secured to or integrally formed to said second opposing end of said first elongated appendage and said second, opposing end of said second elongated member.

16. The wheelchair with protective push rim assembly according to claim 15 wherein said push rim cover comprises a main body sized and shaped to simultaneously cover at least a portion of each wheel of said pair of drive wheels and at least a portion of said at least one push rim.

17. The wheelchair with protective push rim assembly according to claim 16 further including one or more pads secured to an inner surface of said main body.

18. The wheelchair with protective push rim assembly according to claim 17 wherein said one or more pads secured to said inner surface of said main body include an upper contact pad and a lower contact pad, said upper contact pad and said lower contact pad arranged in a generally parallel orientation relative to each other, with a space therebetween.

19. The wheelchair with protective push rim assembly according to claim 17 wherein said space is sized to allow at least a portion of said at least one push rim to move within said space without making contact unless a force is applied to said upper contact pad or said lower contact pad.

20. The wheelchair with protective push rim assembly according to claim 15 wherein said push rim assembly is designed to glide free of friction, forward and rearward, when said one or more pads are not engaged.
